(19) United States
(12) Patent Application Publication
(10) Pub. No.: US 2010/0182810 A1
(43) Pub. Date: Jul. 22, 2010

(54) ALTERNATING-CURRENT POWER SUPPLY DEVICE

(75) Inventor: Toru Ashikaga, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SANKEN ELECTRIC CO., LTD., Niiza-Shi (JP)

(21) Appl. No.: 12/664,698

(22) PCT Filed: Jul. 29, 2008
(86) PCT No.: PCT/JP08/63546

§ 371 Date: Dec. 15, 2009

(30) Foreign Application Priority Data
Aug. 22, 2007 (JP) 2007-216108

(51) Int. Cl. H02M 5/458

(52) U.S. Cl. 363/37

(57) ABSTRACT

An alternating-current power supply device includes: a direct-current power supply Vin; a transformer T1 having a primary winding P1 and a secondary winding S1; a switching element SW1 connected to the direct-current power supply through the primary winding of the transformer; an output circuit 2 that receives a voltage generated at the secondary winding of the transformer and outputs an alternating-current voltage; a control circuit 10 that turns the switching element on and off using a drive signal one cycle of which is a total period of a first period and a second period; and a reset circuit 1 that resets the transformer in the second period. The control circuit generates the drive signal so that a total of on-periods of the switching element may be longer than a total of off-periods thereof in the first period, and generates the drive signal so that a total of off-periods of the switching element may be longer than a total of on-periods thereof in the second period, so that a negative side wave and a positive side wave of the alternating-current voltage wave are almost formed to symmetry.

### TECHNICAL FIELD

The present invention relates to an alternating-current power supply device that converts a direct-current voltage into an alternating-current voltage through a transformer and that supplies the converted alternating-current voltage to a load. Especially, the present invention relate to a technique for supplying an alternating-current voltage to a fluorescent lamp serving as a load to thereby light the fluorescent lamp.

### BACKGROUND ART

An alternating-current power supply device converts a direct-current voltage into an alternating-current voltage through a transformer, and allows load to be driven with the alternating-current voltage. A fluorescent-lamp lighting device is known as an example of a device in which a load is connected to the alternating power supply device. The fluorescent-lamp lighting device uses an alternating-current voltage to light a cold cathode fluorescent lamp serving as a load.

In general, a cold cathode fluorescent lamp (CCFL) is lighted when the alternating-current power supply device applies thereto a voltage of several hundreds V to a thousand and several hundreds V with a frequency of several tens of kHz. Meanwhile, there is a fluorescent tube called an external electrode fluorescent lamp (EEFL). The external electrode fluorescent lamp is different from the cold cathode fluorescent lamp in its electrode structure, but is hardly different in other points, having the same light emitting principle as the cold cathode fluorescent lamp. For this reason, the alternating-current power supply device for lighting the external electrode fluorescent lamp and the alternating-current power supply device for lighting the cold cathode fluorescent lamp are the same in principle. Accordingly, the alternating-current power supply device is described below using the cold cathode fluorescent lamp (called simply a fluorescent lamp below).

The fluorescent lamp and the alternating-current power supply device are used for liquid crystal televisions, liquid crystal monitors, illuminating devices, liquid crystal display devices, billboards and the like. Characteristics required for the alternating-current power supply device are that: (a) the frequency of the alternating-current voltage is about 50 kHz, and (b) a voltage applied to the fluorescent lamp is an alternating-current voltage having a peak-to-peak symmetrical waveform.

Regarding (a), the frequency of a voltage applied to a fluorescent lamp is generally about 10 kHz to 100 kHz. The frequency is determined by a user, considering various characteristics of the fluorescent lamp, such as luminance characteristics, efficiency characteristics, and luminance characteristics of when the fluorescent lamp is incorporated in a set. The alternating-current power supply device is driven with the determined frequency or a frequency close thereto. Accordingly, the frequency oftentimes cannot beset or changed according to the convenience of the alternating-current power supply device. Since the liquid crystal televisions, liquid crystal monitors, illuminating devices, and the like are used with on the order of 50 kHz, an alternating-current power supply device using 50 kHz is used below.

Regarding (b), in general, a voltage applied to the fluorescent lamp needs to be an alternating-current voltage having a peak-to-peak symmetrical waveform. The fluorescent lamp is a glass tube in which mercury, a noble gas, or the like are sealed. The fluorescent lamp lights up even when a direct-current voltage is applied thereto. However, the mercury inside concentrates on one side of the fluorescent lamp, gradually causing a difference in luminance between both ends of the fluorescent lamp. The life of the fluorescent lamp is thus shortened drastically. This is why an alternating-current voltage is applied to the fluorescent lamp. Nevertheless, even with an alternating-current voltage, the mercury might possibly be distributed in an unbalanced manner if the voltage waveform has different forms on the positive side and on the negative side. Therefore, it is required to apply an alternating-current voltage having a peak-to-peak symmetrical waveform. A sine wave and a trapezoidal wave are ideal. In practice, many systems apply a sine-wave voltage.

FIG. 1 is a diagram showing the circuit configuration of a conventional fluorescent-lamp lighting device. This fluorescent-lamp lighting device employs a full-bridge configuration using four switching elements SW1 to SW4. An alternating-current voltage from an alternating-current power supply 25 is rectified by a full-wave rectifier circuit 26 and is smoothed by a smoothing capacitor 27 to obtain a direct-current voltage. The switching elements SW1 to SW4 perform switching for the direct-current voltage to generate a peak-to-peak symmetrical, rectangular-wave signal of 50 kHz. In the device, the rectangular-wave signal is insulated by an insulation transformer T10, and is boosted by a boosting transformer T20 to obtain a peak-to-peak symmetrical sine wave as an alternating-current voltage. In addition, the fluorescent-lamp lighting device can be configured also by a half bridge using two switching elements, similarly to the full-bridge configuration.

These fluorescent-lamp lighting devices use two or more switching elements to obtain a peak-to-peak symmetrical waveform. According to the number of switching elements, the drive circuit for the switching elements increases, such as a high-side driver, a low-side driver, and an insulation element. Consequently, a component cost, a manufacturing cost, and an implementation area also increase. Naturally, the component costs for the switching elements also increase.

For example, Patent Document 1 is known as a conventional technique.

Patent Document 1: JP-A 8-162280

### DISCLOSURE OF THE INVENTION

As described, since more than two switching elements are needed, a component implementation area, a component cost, and a manufacturing cost increase.

An objective of the present invention is to provide an alternating-current power supply device that accomplishes a cost reduction by decreasing the number of switching elements.

To address the above object, the first invention includes: a direct-current power supply; a first transformer having a primary winding and a secondary winding; a first switching element connected to the direct-current power supply through the primary winding of the first transformer; an output circuit that receives a voltage generated at the secondary winding of the first transformer and outputs an alternating-current voltage; a control circuit that turns the first switching element on and off using a drive signal a cycle of which is a total period of a first period and a second period; and a reset circuit that resets the first transformer in the second period, wherein the control circuit generates the drive signal so that a total of on-periods of the first switching element is longer than a total of off-periods thereof in the first period, and generates the drive signal so that a total of the off-periods of the first switching element is longer than a total of the on-periods thereof in the second period, so that a negative side wave and a positive side wave of the alternating-current voltage wave are almost formed to symmetry.

The second invention is characterized in that in an alternating-current power supply device according to the first invention the drive signal is a pulse signal, and number of pulses in one cycle in the drive signal is 1 or more and is fixed.

The third invention is characterized in that in the alternating-current power supply device according to the second invention, the control circuit includes: a first oscillator that generates an oscillation signal having a first frequency; a second oscillator that generates an oscillation signal having a second frequency different from the first frequency of the first oscillator; and a logic circuit that ANDs the oscillation signal of the first oscillator and the oscillation signal of the second oscillator, and the pulse signal is an output signal of the logic circuit.

The fourth invention is characterized in that the alternating-current power supply device according to the second invention including at least one of a voltage detection circuit that detects an output voltage from the output circuit and a current detection circuit that detects an output current from the output circuit, wherein the control circuit includes a pulse-width modulation circuit that modulates a pulse width of the pulse signal, based on an output signal from the at least one of the voltage detection circuit and the current detection circuit.

The fifth invention is characterized in that the alternating-current power supply device according to the third invention including at least one of a voltage detection circuit that detects an output voltage from the output circuit and a current detection circuit that detects an output current from the output circuit, wherein the control circuit includes a pulse-width modulation circuit that modulates a pulse width of the pulse signal, based on an output signal from the at least one of the voltage detection circuit and the current detection circuit.

The sixth invention is characterized in that in the alternating-current power supply device according to the first invention, the first transformer further includes a reset winding that magnetically couples with the primary winding, and the reset circuit is connected in parallel to the direct-current power supply, and is a circuit in which the reset winding and a diode are connected in series to each other.

The seventh invention is characterized in that in the alternating-current power supply device according to the first invention, the reset circuit is connected in parallel to the primary winding of the first transformer, and is a circuit in which a parallel circuit of a resistance and a capacitor is connected in series to a diode.

The eighth invention is characterized in that in the alternating-current power supply device according to the first invention, the reset circuit is connected in parallel to the primary winding of the first transformer, and is a circuit in which a capacitor and a second switching element are connected in series to each other.

The ninth invention is characterized in that in the alternating-current power supply device according to the first invention, the output circuit is connected in parallel to the secondary winding of the first transformer, is a circuit in which a first reactor and a first capacitor are connected in series to each other, and outputs the alternating-current voltage from the first capacitor.

The tenth invention is characterized in that in the alternating-current power supply device according to the first invention, the output circuit is a circuit in which a second reactor and a primary winding of a second transformer are connected in series with respect to the secondary winding of the first transformer, and a secondary winding of the second transformer and a second capacitor are connected in parallel to each other, and the output circuit outputs the alternating-current voltage from the second capacitor.

The eleventh invention is characterized in that in the alternating-current power supply device according to the ninth invention, the first reactor is formed of a leakage inductance of the first transformer.

The twelfth invention is characterized in that in the alternating-current power supply device according to the tenth invention, the second reactor is formed of a leakage inductance of the second transformer.

The 13th invention is characterized in that in the alternating-current power supply device according to the tenth invention, the second reactor is formed of a leakage inductance of the first transformer and a leakage inductance of the second transformer.

### BRIEF DESCRIPTION OF THE DRAWINGS

FIG. 1 is a diagram showing a configuration example of a conventional fluorescent-lamp lighting device.

FIG. 2 is a diagram showing the configuration of a fluorescent-lamp lighting device of Embodiment 1 of the present invention.

FIG. 3 is a timing chart showing waveforms of respective components obtained when a switching element driven with a single pulse has a small duty ratio and a large duty ratio.

FIG. 4 is a timing chart showing waveforms of the respective components obtained when the switching element of the fluorescent-lamp lighting device of Embodiment 1 driven with two pulses has a small duty ratio and a large duty ratio.

FIG. 5 is a timing chart showing waveforms of the respective components obtained when the duty ratio of the pulse signal is 50% or lower.

FIG. 6 is a diagram showing the configuration of a fluorescent-lamp lighting device of Embodiment 2 of the present invention.

FIG. 7 is a diagram showing the configuration of a fluorescent-lamp lighting device of Embodiment 3 of the present invention.

FIG. 8 is a diagram showing the configuration of a fluorescent-lamp lighting device of Embodiment 4 of the present invention.

FIG. 9 is a timing chart showing waveforms of respective components of the fluorescent-lamp lighting device of Embodiment 4 of the present invention.

FIG. 10 is a timing chart showing waveforms of respective components obtained when an output signal from a first oscillator and an output signal from a second oscillator are not synchronized.

FIG. 11 is a diagram showing an example of a method for generating two signals in which a frequency of the first oscillator and a frequency of the second oscillator are synchronized with each other in the fluorescent-lamp lighting device of Embodiment 4 of the present invention.

FIG. 12 is a diagram showing another example of the method for generating synchronized two signals in the fluorescent-lamp lighting device of Embodiment 4.

FIG. 13 is a diagram showing an example of a ¼ frequency divider circuit.

FIG. 14 is a diagram showing the configuration of a fluorescent-lamp lighting device of Embodiment 5 of the present invention.

FIG. 15 is a diagram showing the configuration of a fluorescent-lamp lighting device of Concrete Example 1 of Embodiment 6 of the present invention.

FIG. 16 is a diagram showing the configuration of a fluorescent-lamp lighting device of Concrete Example 2 of Embodiment 6 of the present invention.

FIG. 17 is a diagram showing the configuration of a fluorescent-lamp lighting device of Concrete Example 1 of Embodiment 7 of the present invention.

FIG. 18 is a diagram showing the configuration of a fluorescent-lamp lighting device of Concrete Example 2 of Embodiment 7 of the present invention.

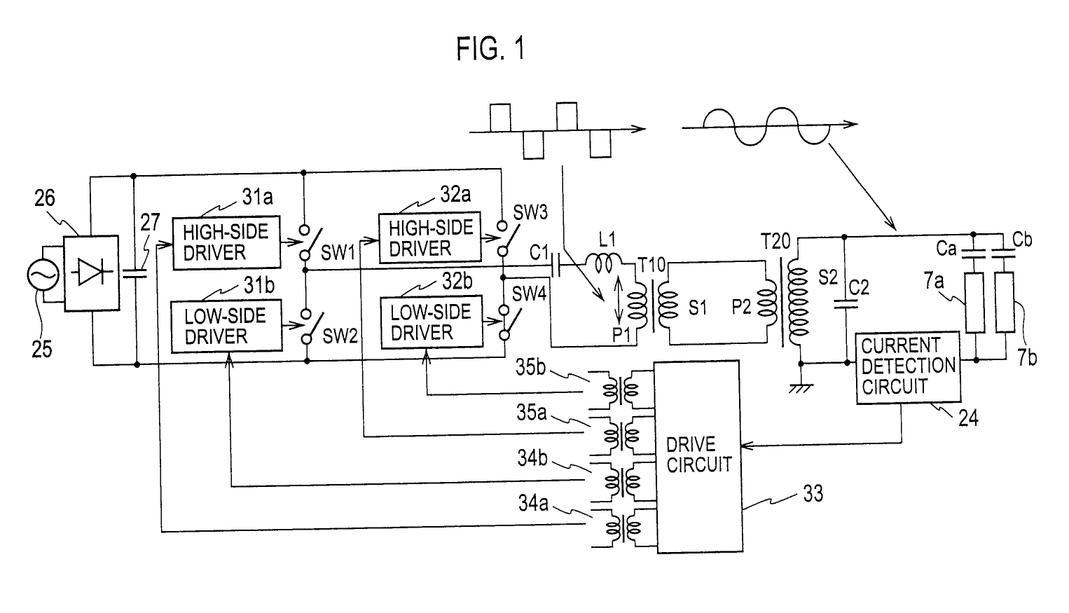

### BEST MODES FOR CARRYING OUT THE INVENTION

With reference to the drawings, embodiments of an alternating-current power supply device of the present invention are described in detail below. The following embodiments are described, taking a case where the alternating-current power supply device of the present invention is applied to a fluorescent-lamp lighting device. This fluorescent-lamp lighting device is configured by connecting a fluorescent lamp as a load, to the alternating-current power supply device of the present invention.

The load is a fluorescent lamp in the following examples; however, it should be noted that the load does not necessarily have to be the fluorescent lamp, and the alternating-current power supply device of the present invention may be applied to other types of load.

### Embodiment 1

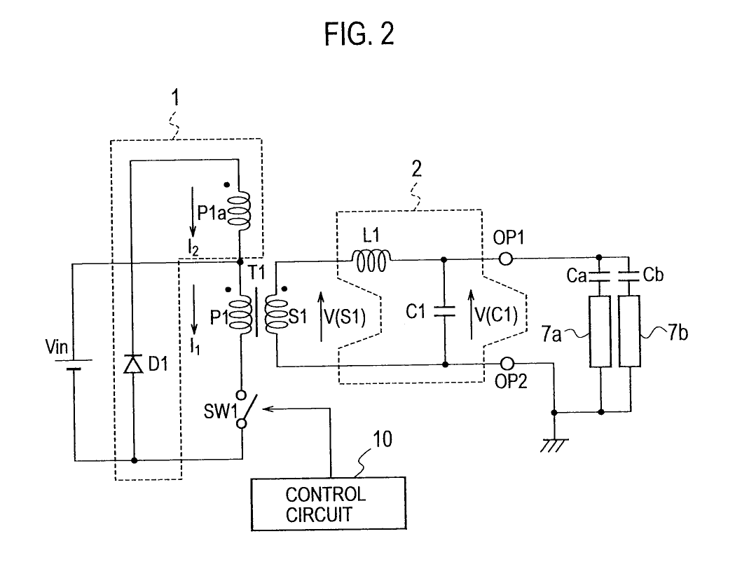

FIG. 2 is a diagram showing the configuration of a fluorescent-lamp lighting device of Embodiment 1 of the present invention. In FIG. 2, a series circuit of a primary winding P1 of a transformer T1 (first transformer) and a switching element SW1 (first switching element) formed of a MOSFET or the like is connected to both ends of a DC power supply Vin.

One end of a reset winding P1a is connected to the primary winding P1 of the transformer T1. The primary winding P1 of the transformer T1 is magnetically coupled to the reset winding P1a. The other end (the side denoted by •) of the reset winding P1a of the transformer T1 is connected to the cathode of a diode D1. The anode of the diode D1 is connected to the negative terminal of the DC power supply Vin. The reset winding P1a of the transformer T1 and the diode D1 form a reset circuit 1.

A series circuit of a reactor L1 (first reactor) and a capacitor C1 (first capacitor C1) is connected to both ends of a secondary winding S1 of the transformer T1. The reactor L1 and the capacitor C1 form an output circuit 2 that receives a voltage generated at the secondary winding S1 of the transformer T1 and then outputs an alternating-current voltage to output terminals OP1, OP2. A leakage inductance of the transformer T1 may be used as the reactor L1. The capacitor C1 is connected at both ends to a series circuit of a capacitor Ca and a fluorescent lamp 7a, and to a series circuit of a capacitor Cb and a fluorescent lamp 7b.

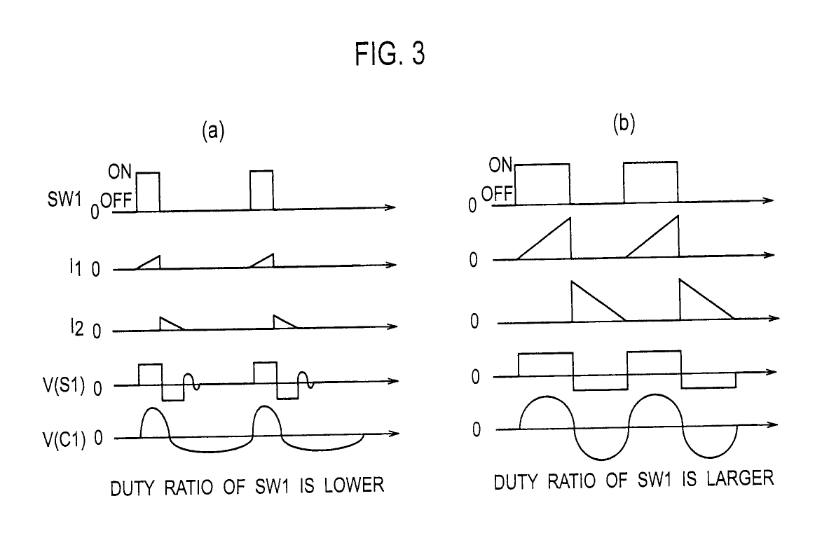

FIG. 3 is a timing chart showing waveforms of the respective components obtained with a small duty ratio and a large duty ratio, respectively, of the switching element driven with a single pulse.

Here, the duty ratio is an on-duty ratio of a pulse signal. Specifically, in one cycle of a pulse signal, the duty ratio is 100*pulse-on period/(pulse-on period)+pulse-off period), and is expressed in percentage.

As FIG. 3 shows, the switching element SW1 is turned on and off with 50 kHz for example. During an on-period of the switching element SW1, a current I1 flows to the primary winding P1 of the transformer T1 by way of Vin→P1→SW1→Vin, so that a positive voltage is generated at the secondary winding S1 of the transformer T1.

During an off-period of the switching element SW1, a reset current 12 flows to the reset winding P1a of the transformer T1 by way of P1→Vin→D1→P1a. Accordingly, at the time when the switching element SW1 is turned off, the reset winding P1a resets an exciting energy of the transformer T1. In addition, during this reset period, a negative voltage is generated at the secondary winding S1 of the transformer T1.

In this way, an alternating-current voltage V(S1) having a rectangular wave is generated at the secondary winding S1 of the transformer T1. Then, an alternating-current voltage V(C1) having a sine wave is obtained after the filtering actions by the reactor L1 and the capacitor C1. The alternating-current voltage V(C1) is a voltage across the capacitor C1.

As shown in FIG. 3(a), when the duty ratio of the switching element SW1 is small, the alternating-current voltage does not have a positive and negative symmetrical wave. When the duty ratio of the switching element SW1 is large, on the other hand, an alternating-current voltage V(C1) having a positive and negative symmetrical sine wave is obtained. For this reason, when used with the duty ratio being close to 50%, the circuit is effective.

However, the alternating-current voltage V(C1) cannot be controlled if the duty ratio is fixed at 50%. To control the intensity of a fluorescent lamp, a voltage applied and a current flowing to the fluorescent lamp need to be controlled. To do so, the duty ratio of the switching element SW1 needs to be controlled. This may lead to decrease in the duty ratio, depending on the conditions, and thus may make it impossible to output a positive and negative symmetrical sine wave. The reason why a positive and negative symmetrical sine wave cannot be obtained is that the period in which the voltage V(S1) of the secondary winding S1 of the transformer T1 is positive is short with respect to one cycle.

In this respect, in Embodiment 1, a control circuit 10 is provided to turn the switching element SW1 on and off using a drive signal one cycle of which is the total period of a first period and a second period. The control circuit 10 generates the drive signal so that, in the first period, the total of on-periods of the switching element SW1 may be longer than the total of off-periods thereof, and generates the drive signal so that, in the second period, the total of the off-periods of the switching element SW1 may be longer than the total of the on-periods. Thereby, a negative side wave and a positive side wave of an alternating-current voltage wave are almost formed to symmetry.

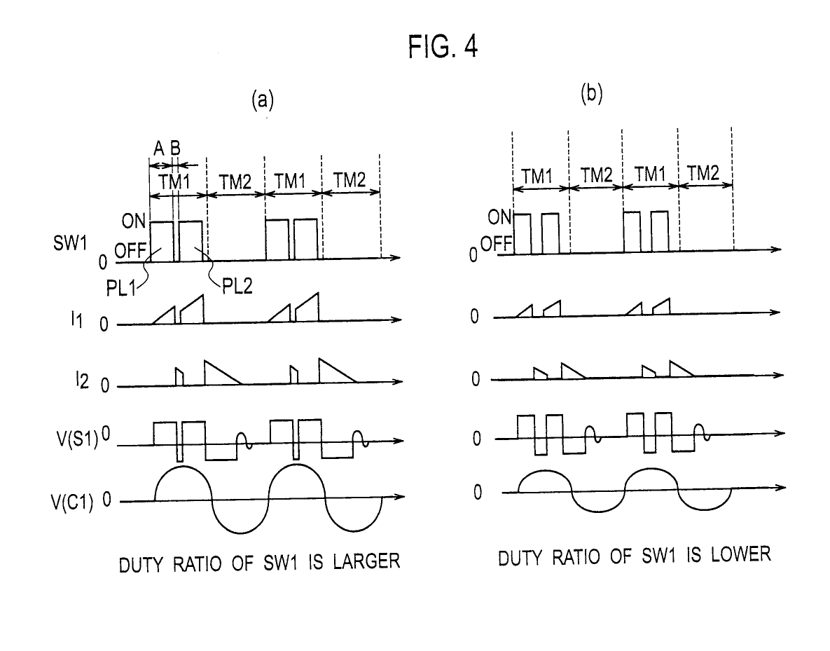

FIG. 4 is a timing chart showing waveforms of the respective components obtained with a small duty ratio and a large duty ratio, respectively, of the switching element of a fluorescent-lamp lighting device of Embodiment 1 driven with two pulses. In FIG. 4, one cycle of the drive signal of the switching element SW1 is the total period of a period TM1 (first period) and a period TM2 (second period). The drive signal is generated so that, in the first period TM1, the total (2A) of on-periods (on-periods of respective pulses PL1, PL2) of the switching element SW1 may be longer than the total of off-periods (2B) thereof. Moreover, the drive signal is generated so that, in the second period TM2, the total of the off-periods of the switching element SW1 maybe longer than the total of the on-periods thereof.

FIG. 4(a) shows waveforms of the respective components obtained when the duty ratio of a drive signal is large; FIG. 4(b) shows waveforms of the respective components obtained when the duty ratio of a drive signal is small. Here, in the example shown in FIG. 4(a), the duty ratio is 100*A/(A+B). There are two pulses PL1, PL2 in the period TM1. Accordingly, even when the duty ratio is small, a long positive voltage period can be secured for the voltage V(S1) of the secondary winding of the transformer T1. Consequently, the waveform of the alternating-current voltage V(C1) can be close to a positive and negative symmetrical sine wave.

Moreover, for example, when the period in which the pulse signals exist is the period TM1 and the period in which the pulse signals do not exist is the period TM2 as shown in FIG. 4, the control circuit 10 can control the frequency of the alternating-current voltage to make the frequency constant, by controlling the total period of the period A and the period B so that the total period may be a fixed value. Moreover, the control circuit 10 can change the frequency of the alternating-current voltage by changing the total period of the period TM1 and the period TM2.

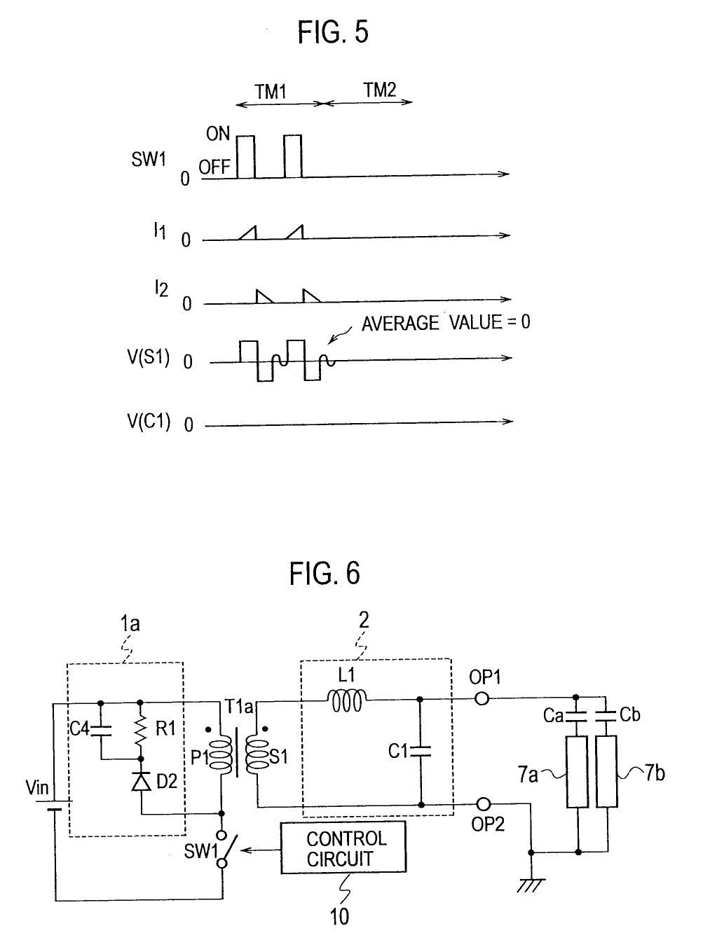

Next, the duty ratio of a pulse signal is considered. In FIG. 2, when the duty ratio of a pulse signal is 50% or lower, an average value of a pulse signal in each of the period TM1 and the period TM2 is zero. Accordingly, when the switching element SW1 is driven with a duty ratio of 50% or lower, almost no alternating-current voltage V(C1) is generated at the capacity C1 as shown in FIG. 5. For this reason, the duty ratio of at least one pulse signal in the period TM1 needs to be larger than 50% (namely, the on-period of the pulse signal needs to be longer than the off-period thereof), and the duty ratio of at least one pulse signal in the period TM2 needs to be smaller than 50% (namely, the off-period of the pulse signal needs to be longer than the on-period thereof).

In other words, to drive the switching element SW1 with a duty ratio exceeding 50% is to operate the switching element SW1 without resetting the exciting energy of the primary winding P1 of the transformer T1. This operation causes a voltage at the capacitor C1. In addition, in the period TM2, the duty ratio does not have to be zero as long as it is 50% or lower.

Although two pulses are inserted in the period TM1 in Embodiment 1, similar effects can be obtained even with three or more pulses.

As described, according to Embodiment 1, a single switching element SW1 is used. Moreover, the control circuit 10 generates a drive signal (pulse signal) so that, in the period TM1, the total of on-periods of the switching element SW1 may be longer than the total of the off-periods, and generates a drive signal so that, in the second period, the total of the off-periods of the switching element SW1 maybe longer than the total of the on-periods. Consequently, the output circuit is allowed to form an alternating-current voltage having the waveform of a positive and negative symmetrical sine wave. Thereby, the number of switching elements can be reduced.

### Embodiment 2

FIG. 6 is a diagram showing the configuration of a fluorescent-lamp lighting device of Embodiment 2 of the present invention. A series circuit of a primary winding P1 of a transformer T1 and a switching element SW1 is connected to both ends of a direct-current power supply Vin. A reset circuit la is connected in parallel to the primary winding P1 of the transformer T1a, and is a circuit in which a parallel circuit of a resistance R1 and a capacitor C4 is connected in series to a diode D2. The other configurations shown in FIG. 6 are the same as the configurations of Embodiment 1 shown in FIG. 2.

According to such configuration of Embodiment 2, when the switching element SW1 is off, an exciting energy of the transformer T1 is accumulated at the capacitor C4 via the diode D2 and is consumed by the resistance R1. Accordingly, the reset circuit 1a can reset the exciting energy induced to the primary winding P1 of the transformer T1. Thereby, effects similar to those of Embodiment 1 can be obtained.

### Embodiment 3

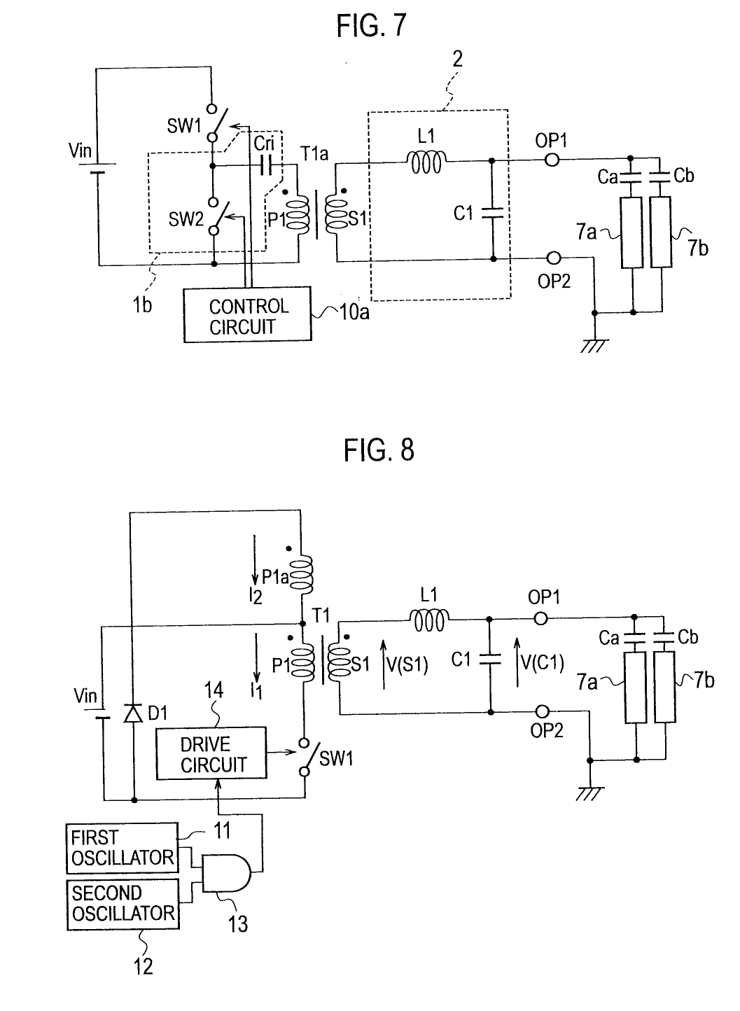

FIG. 7 is a diagram showing the configuration of a fluorescent-lamp lighting device according to Embodiment 3 of the present invention. The circuit shown in FIG. 7 is a half-bridge circuit. A series circuit of a switching element SW1 and a switching element SW2 formed of a MOSFET or the like is connected to both ends of a DC power supply Vin. A reset circuit 1b is connected in parallel to a primary winding P1 of a transformer T1a, and is a circuit in which a current resonance capacitor Cri (second capacitor) is connected in series to the switching element SW2 (second switching element).

The other configurations shown in FIG. 7 are the same as the configurations of Embodiment 1 shown in FIG. 2. A control circuit 10a has functions of the control circuit 10 shown in FIG. 2, and also turns the switching element SW1 and the switching element SW2 on and off alternately.

According to such configuration of Embodiment 3, when the switching element SW1 is on, a current flows by way of Vin→SW1→Cri→P1→Vin, and the energy is accumulated at the current resonance capacitor Cri and the primary winding P1 of the transformer T1a. When the switching element SW1 is off and the switching element SW2 is on, a current flows by way of P1→Cri→SW2→P1. Accordingly, the reset circuit 1b can reset the exciting energy of the transformer T1.

Thereby, effects similar to those of Embodiment 1 can be obtained by such configuration of Embodiment 3.

### Embodiment 4

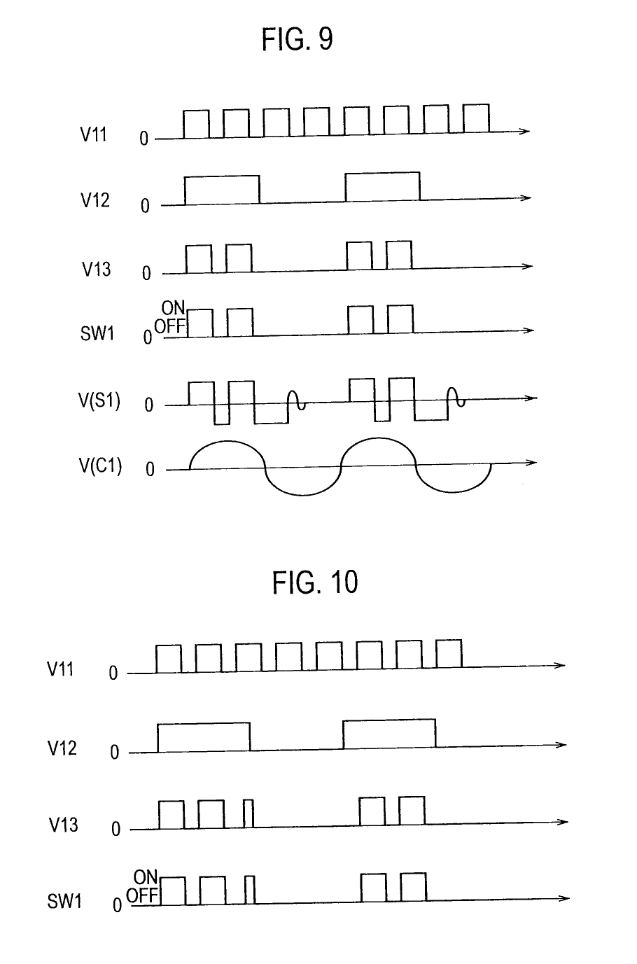

FIG. 8 is a diagram showing the configuration of a fluorescent-lamp lighting device of Embodiment 4 of the present invention. Embodiment 4 shown in FIG. 8 is what the control circuit 10 of Embodiment 1 shown in FIG. 2 is embodied. Specifically, as a control circuit, a first oscillator 11, a second oscillator 12, an AND circuit 13, and a drive circuit 14 are provided. FIG. 9 is a timing chart of waveforms of the respective components of the fluorescent-lamp lighting device of Embodiment 4 of the present invention.

The first oscillator 11 generates a voltage (oscillation signal) V11 of for example 200 kHz (first frequency) having a rectangular wave. The second oscillator 12 generates a voltage (oscillation signal) V12 of for example 50 kHz (second frequency) having a rectangular wave. The AND circuit 13 (logic circuit) generates a drive signal for the switching element SW1 by ANDing the rectangular-wave voltage V11 of 200 kHz of the first oscillator 11 and the rectangular-wave voltage V12 of 50 kHz of the second oscillator 12. The drive circuit 14 drives the switching element SW1 using the drive signal V13 from the AND circuit 13.

The period TM1 and the period TM2 are determined by the duty ratio of the oscillation signal from the second oscillator 12. It is generally desirable to set the duty ratio of the oscillation signal from the second oscillator 12 to about 50%. For this reason, the switching element SW1 is oscillated intermittently by a signal of 50 kHz having a duty ratio of about 50%. In addition, the alternating-current voltage V(C1) can be controlled by changing the duty ratio of the oscillation signal from the first oscillator 11.

In FIG. 8, when the first oscillator 11 and the second oscillator 12 are operated individually, minor fluctuations and variations in frequencies occur, causing fluctuations in the number of pulses in one cycle in a pulse signal, as shown in FIG. 10. With such pulse signal, an alternating-current voltage in the output circuit is not stable.

Accordingly, it is effective to synchronize the signal of the first oscillator 11 with the signal of the second oscillator 12. Here, to synchronize the signals is to keep constant the number of pulses (for example, 2 pulses) of a drive signal for the switching element SW1 in one cycle of an alternative voltage (the one cycle is the total period of the period TM1 and the period TM2, e.g., a period of 50 kHz). The fluctuations in an alternating-current voltage can be suppressed since the number of pulses of a drive signal for the switching element SW1 in one cycle of an alternating-current voltage is constant.

Synchronized two signals can be generated easily with a frequency divider circuit, a frequency multiplier circuit, or the like using, for example, a flip-flop, a timer, a counter, or the like.

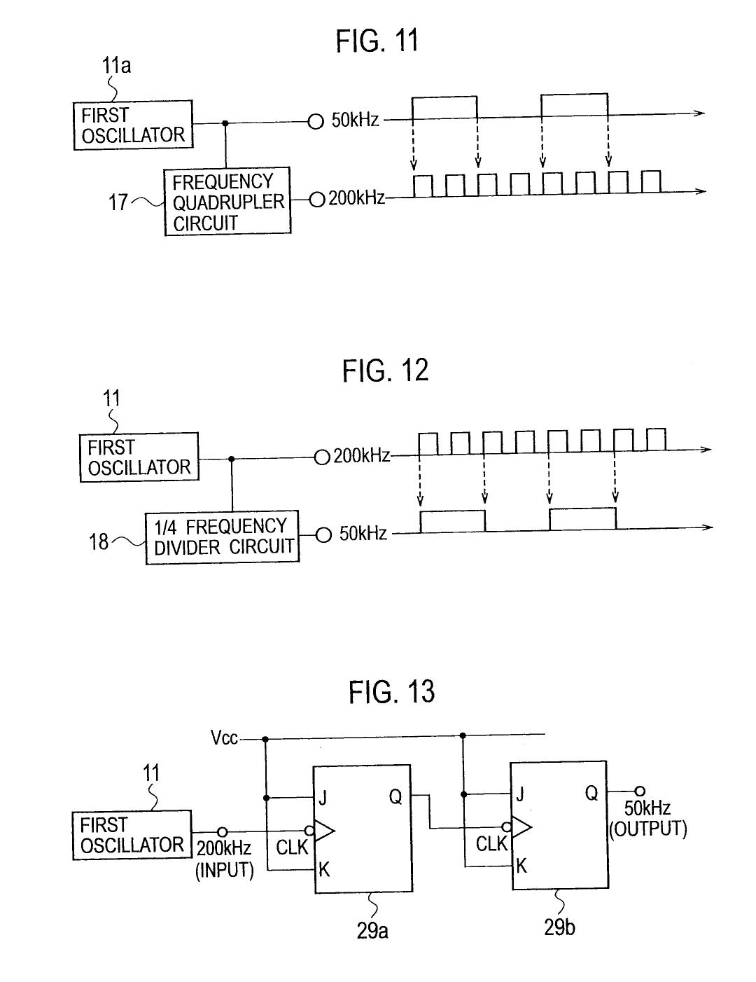

In the example shown in FIG. 11, a frequency quadrupler circuit 17 as a second oscillator quadruples the frequency of a reference signal having 50 kHz of a first oscillator 11a and thus generates a reference signal having 200 kHz.

In the example shown in FIG. 12, a ¼ frequency divider circuit 18 as a second oscillator divides the frequency of a signal having 200 kHz of the first oscillator 11 to ¼ and thus generates a reference signal having 50 kHz.

In the examples shown in FIGS. 11 and 12, by changing the frequency division ratio or frequency multiplication number of the first oscillator 11 and the frequency divider circuit 18 or the frequency multiplier 17 as the second oscillator, two synchronized signals with any selected frequency can be generated easily.

Moreover, as FIG. 13 shows, the first oscillator 11 and a second oscillator including JK flip-flops 29a, 29b are provided. A signal having 200 kHz from the first oscillator 11 is inputted into a clock terminal CLK of the JK flip-flop 29a. The JK flip-flop 29a generates a signal having 100 kHz from the signal having 200 kHz, and then outputs the generated signal to a clock terminal CLK of the JK flip-flop 29b. The JK flip-flop 29b generates a signal having 50 kHz from the signal having 100 kHz.

Synchronization of a drive signal for the switch SW1 with the frequency of an alternating-current voltage is only what should be accomplished here, and synchronization between the oscillator outputs is merely an example.

### Embodiment 5

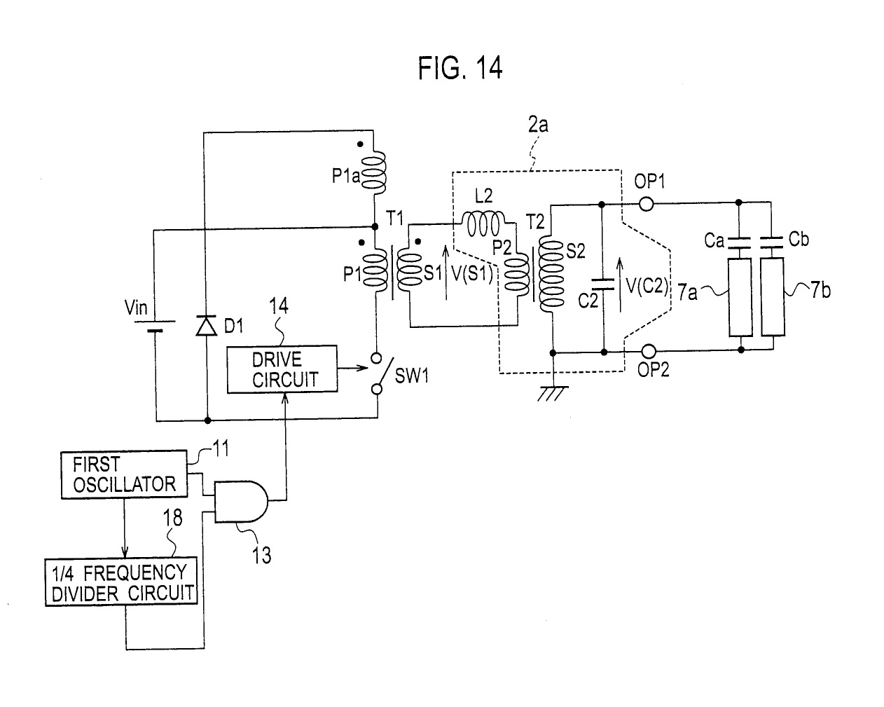

FIG. 14 is a diagram showing the configuration of a fluorescent-lamp lighting device of Embodiment 5 of the present invention. In Embodiment 4 shown in FIG. 8, a high voltage having a rectangular wave is generated at the secondary winding S1 of the transformer T1, and this voltage is subjected to the filtering actions by the reactor L1 and the capacitor C1 to obtain a voltage having a sine wave.

Here, for example, if the transformer T1 performs insulation in the system shown in FIG. 8, the transformer T1 needs to meet conditions specified by various safety standards, such as an insulation distance. In this case, the higher the voltage at the secondary winding S1 of the transformer T1, the stricter the conditions, so that the transformer T1 increases in its size and price. For this reason, the voltage at the secondary winding S1 needs to be restricted to a low voltage. Further, a fractional slot winding or the like is needed to handle a high voltage applied to the reactor L1, causing an increase in size and price.

To address this, in Embodiment 5 shown in FIG. 14, a primary winding P2 of a transformer T2 (second transformer) being a boosting transformer and a reactor L2 (second reactor) are connected to both ends of a secondary winding S1 of a transformer T1. A capacitor C2 is connected in parallel to both ends of the secondary winding S2 of the transformer T2, and an alternating-current voltage V(C2) is obtained from the capacitor C2.

In addition, the transformer T2, the reactor L2, and the capacitor C2 form an output circuit 2a that receives a voltage generated at the secondary winding S2 of the transformer T2 and then outputs an alternating-current voltage to output terminals OP1, OP2.

According to such configuration of Embodiment 5, the transformer T1 performs insulation required by the various safety standards, and the transformer T2 performs boosting. Accordingly, the above problems can be avoided. Moreover, since the transformer T1 generates a lower voltage having a rectangular wave, the transformer T1 can loose conditions of the various safety standards. Being a booster at the secondary side, the transformer T2 only has to perform so-called functional insulation.

In addition, as the reactor L2 shown in FIG. 14, a leakage inductance between the primary winding P2 and the secondary winding S2 of the transformer T2 may be used.

Alternatively, a leakage inductance of the transformer T1 and a leakage inductance of the transformer T2 may be used as the reactor L2 shown in FIG. 14.

### Embodiment 6

A fluorescent-lamp lighting device stably lights a fluorescent lamp by detecting a current flowing into the fluorescent lamp and controlling the detected current to set to a predetermined value. As such a method, a method for detecting a current flowing into a fluorescent lamp is frequently used.

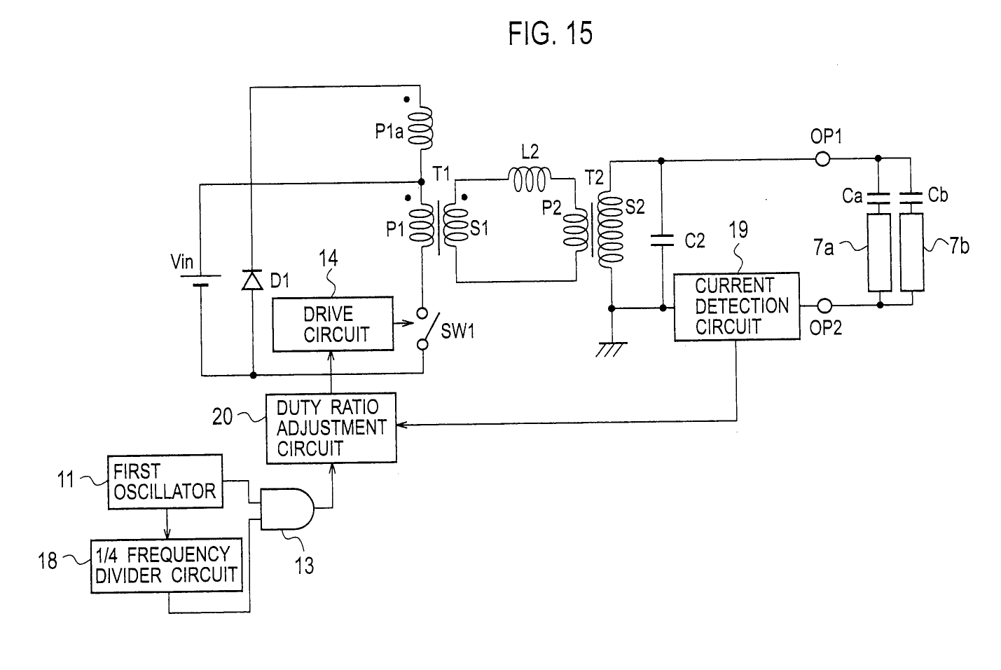

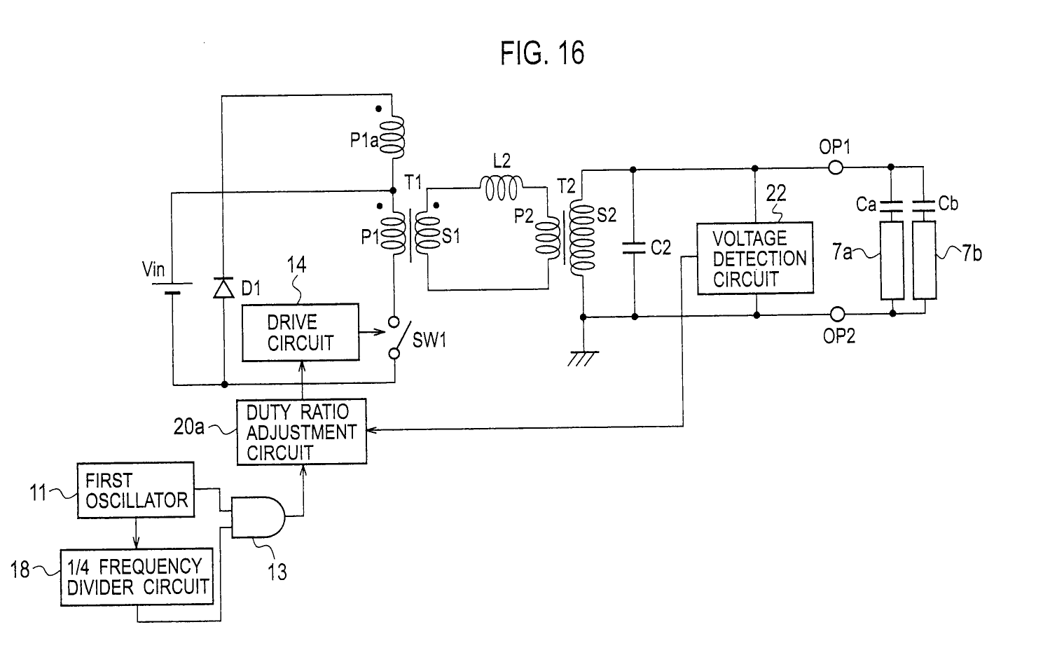

However, the current to the fluorescent lamp cannot always be detected because of application constraints, structural constraints, or the like. In this case, current control can be performed also by detecting other electricity amount. FIG. 15 is a diagram showing the configuration of a fluorescent-lamp lighting device of Concrete Example 1 of Embodiment 6 of the present invention. FIG. 16 is a diagram showing the configuration of a fluorescent-lamp lighting device of Concrete Example 2 of Embodiment 6 of the present invention.

In Concrete Example 1 of Embodiment 6 shown in FIG. 15, a current detection circuit 19 connected in series to fluorescent lamps 7a, 7b detects a current flowing to the fluorescent lamps 7a, 7b. A duty-ratio adjustment circuit 20 is connected between an AND circuit 13 and a drive circuit 14, and changes the duty ratio of a pulse signal of a switching element SW1 so that the current detected by the current detection circuit 19 may be set to a predetermined value. Accordingly, the duty-ratio adjustment circuit 20 is formed of a publicly known pulse-width modulation circuit that modulates a pulse width of a pulse signal.

In Concrete Example 2 of Embodiment 6 shown in FIG. 16, a voltage detection circuit 22 connected between both ends of a secondary winding S2 of a transformer T2 detects a voltage (alternating-current voltage) at the secondary winding of the transformer T2. A duty-ratio adjustment circuit 20a is connected between an AND circuit 13 and a drive circuit 14, and changes the duty ratio of a pulse signal of a switching element SW1 so that the voltage detected by the voltage detection circuit 22 may be set to a predetermined value. Accordingly, the duty-ratio adjustment circuit 20a is formed of a publicly known pulse-width modulation circuit that modulates a pulse width of a pulse signal.

### Embodiment 7

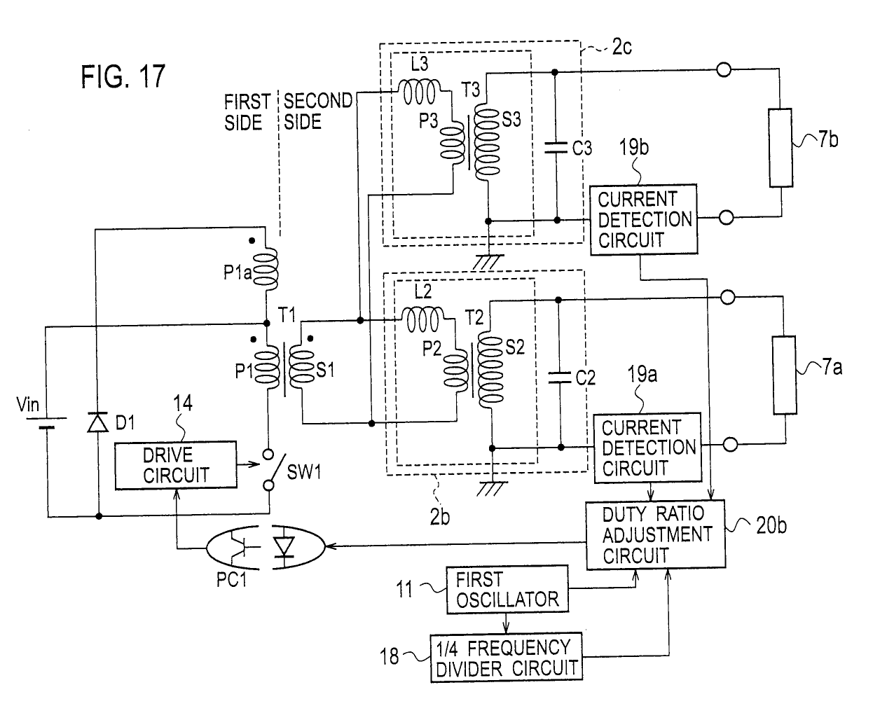

FIG. 17 is a diagram showing the configuration of a fluorescent-lamp lighting device of Concrete Example 1 of Embodiment 7 of the present invention. Embodiment 7 shown in FIG. 17 has a configuration in which a transformer T3, a current detection circuit 19b, and a photocoupler PC1 are further provided to the configuration shown in FIG. 15.

A primary winding P3 of the transformer T3 and a reactor L3 are respectively connected to both ends of the secondary winding S1 of the transformer T1. A capacitor C3 and a series circuit of the fluorescent lamp 7b and the current detection circuit 19b are connected to both ends of a secondary winding S3 of the transformer T3.

A duty-ratio adjustment circuit 20b adjusts the duty ratio of a pulse signal of the switching element SW1, based on a signal from the first oscillator 11, a signal from the ¼ frequency divider circuit 18 serving as the second oscillator, a detected current from a current detection circuit 19a, and a detected current from the current detection circuit 19b. The photocoupler PC1 flows a current which is in accordance with an output from the duty-ratio adjustment circuit 20b. The drive circuit 14 drives the switching element SW1 on and off, using an output signal from the photocoupler PC1, namely, a pulse signal the duty ratio of which has been adjusted.

In this way, multiple fluorescent lamps 7a, 7b can be lighted using multiple boosting transformers T2, T3.

In Concrete Example 1 of Embodiment 7, there are two fluorescent lamps. However, more fluorescent lamps can be lighted at the same time by increasing the number of transformers.

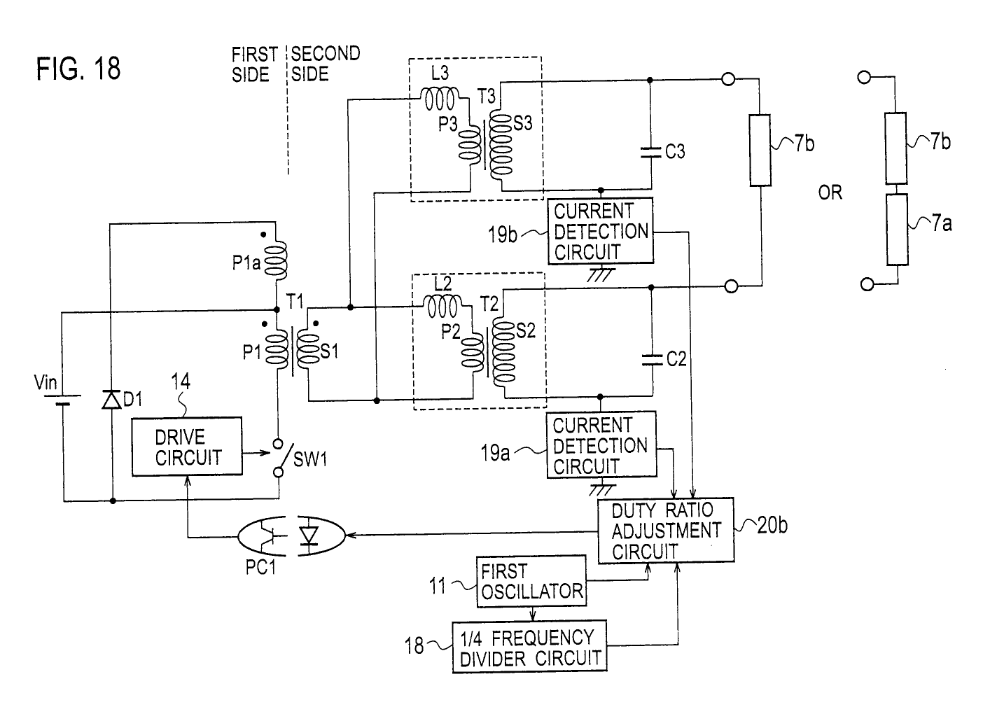

Moreover, as illustrated in Concrete Example 2 of Embodiment 7 shown in FIG. 18, a single lamp 7b or multiple fluorescent lamps 7a, 7b may be connected between the high-voltage side of the transformer T2 and the high-voltage side of the transformer T3 to light a single or multiple fluorescent lamps with the two transformers T2, T3.

According to the present invention, a control circuit uses a single switching element to generate drive signals in the following manner. Specifically, the control circuit generates a drive signal so that, in the first period, the total of on-periods of a first switching element may be longer than the total of the off-periods thereof, and generates a drive signal so that, in the second period, the total of off-periods of the first switching element may be longer than the total of the on-periods thereof. Consequently, a negative side wave and a positive side wave of an alternating-current voltage wave almost can be formed to symmetry in an output circuit. Accordingly, the number of switching elements can be reduced.

### INDUSTRIAL APPLICABILITY

The present invention is applicable to a power supply device such as a DC-AC converter.

1. An alternating-current power supply device, comprising:
a direct-current power supply;
a first transformer having a primary winding and a secondary winding;
a first switching element connected to the direct-current power supply through the primary winding of the first transformer;
an output circuit that receives a voltage generated at the secondary winding of the first transformer and outputs an alternating-current voltage;
a control circuit that turns the first switching element on and off using a drive signal one cycle of which is a total of a first period and a second period; and
a reset circuit that resets the first transformer in the second period, wherein
the control circuit generates the drive signal so that a total of on-periods of the first switching element is longer than a total of off-periods thereof in the first period, and generates the drive signal so that a total of the off-periods of the first switching element is longer than a total of the on-periods thereof in the second period, so that a negative side wave and a positive side wave of the alternating-current voltage wave are almost formed to symmetry.

2. The alternating-current power supply device according to claim 1, wherein
the drive signal is a pulse signal, and
number of pulses in one cycle in the drive signal is 1 or more and is fixed.

3. The alternating-current power supply device according to claim 2, wherein
the control circuit includes:
a first oscillator that generates an oscillation signal having a first frequency;
a second oscillator that generates an oscillation signal having a second frequency different from the first frequency of the first oscillator; and
a logic circuit that ANDs the oscillation signal of the first oscillator and the oscillation signal of the second oscillator, and
the pulse signal is an output signal of the logic circuit.

4. The alternating-current power supply device according to claim 2, comprising at least one of a voltage detection circuit that detects an output voltage from the output circuit and a current detection circuit that detects an output current from the output circuit, wherein
the control circuit includes a pulse-width modulation circuit that modulates a pulse width of the pulse signal, based on an output signal from the at least one of the voltage detection circuit and the current detection circuit.

5. The alternating-current power supply device according to claim 3, comprising at least one of a voltage detection circuit that detects an output voltage from the output circuit and a current detection circuit that detects an output current from the output circuit, wherein
the control circuit includes a pulse-width modulation circuit that modulates a pulse width of the pulse signal, based on an output signal from the at least one of the voltage detection circuit and the current detection circuit.

6. The alternating-current power supply device according to claim 1, wherein
the first transformer further includes a reset winding that magnetically couples with the primary winding, and
the reset circuit is connected in parallel to the direct-current power supply, and is a circuit in which the reset winding and a diode are connected in series to each other.

7. The alternating-current power supply device according to claim 1, wherein
the reset circuit is connected in parallel to the primary winding of the first transformer, and is a circuit in which a parallel circuit of a resistance and a capacitor is connected in series to a diode.

8. The alternating-current power supply device according to claim 1, wherein
the reset circuit is connected in parallel to the primary winding of the first transformer, and is a circuit in which a capacitor and a second switching element are connected in series to each other.

9. The alternating-current power supply device according to claim 1, wherein
the output circuit is connected in parallel to the secondary winding of the first transformer, is a circuit in which a first reactor and a first capacitor are connected in series to each other, and outputs the alternating-current voltage from the first capacitor.

10. The alternating-current power supply device according to claim 1, wherein
the output circuit is a circuit in which
a second reactor and a primary winding of a second transformer are connected in series with respect to the secondary winding of the first transformer, and
a secondary winding of the second transformer and a second capacitor are connected in parallel to each other, and
the output circuit outputs the alternating-current voltage from the second capacitor.

11. The alternating-current power supply device according to claim 9, wherein
the first reactor is formed of a leakage inductance of the first transformer.

12. The alternating-current power supply device according to claim 10, wherein
the second reactor is formed of a leakage inductance of the second transformer.

13. The alternating-current power supply device according to claim 10, wherein
the second reactor is formed of a leakage inductance of the first transformer and a leakage inductance of the second transformer.
